(19) United States
(12) Patent Application Publication
(10) Pub. No.: US 2025/0283306 A1
(43) Pub. Date: Sep. 11, 2025

(54) WORK MACHINE AND CONTROL SYSTEM FOR WORK MACHINE

(71) Applicant: SUMITOMO CONSTRUCTION MACHINERY CO., LTD., Tokyo (JP)

(72) Inventor: Yuiki MATSUHASHI, Chiba (JP)

(21) Appl. No.: 19/065,337

(22) Filed: Feb. 27, 2025

(30) Foreign Application Priority Data
Mar. 11, 2024 (JP) 2024-037494

(51) Int. Cl. E02F 9/26; E02F 3/32; E02F 9/20; E02F 9/22

(52) U.S. Cl. CPC E02F 9/261; E02F 9/2004; E02F 3/32; E02F 9/205; E02F 9/2203; E02F 9/2285; E02F 9/2292; E02F 9/2296

(57) ABSTRACT

A work machine includes a lower traveling body; an upper turning body mounted on the lower traveling body so as to freely turn; a sound collecting device provided on the upper turning body so as to be able to detect a direction of a sound around the work machine; and a control device configured to report a direction of speech based on the direction of the sound detected by the sound collecting device, when a person existing around the work machine is speaking.

### CROSS-REFERENCE TO RELATED APPLICATION

The present application is based on and claims priority under 35 U.S.C. § 119 to Japanese Patent Application No. 2024-037494, filed on Mar. 11, 2024, the contents of which are incorporated herein by reference in their entirety.

### BACKGROUND

### Technical Field

The present invention relates to a work machine and a control system for the work machine.

### Description of Related Art

In the related art, workers often work around an excavator. Therefore, in the case of an excavator, a technique for detecting a person existing around the excavator based on an image captured by an imaging device mounted on an upper turning body is known.

### SUMMARY

According to an embodiment of the present invention, there is provided a work machine including a lower traveling body; an upper turning body mounted on the lower traveling body so as to freely turn; a sound collecting device provided on the upper turning body so as to be able to detect a direction of a sound around the work machine; and a control device configured to report a direction of speech based on the direction of the sound detected by the sound collecting device, when a person existing around the work machine is speaking.

### BRIEF DESCRIPTION OF THE DRAWINGS

FIG. 1 is a side view of a work machine according to an embodiment;

FIG. 2 is a top view of a work machine according to the embodiment;

FIG. 3 is a diagram illustrating an example of the configuration of an external sound collecting device and an information transmission device attached to the work machine illustrated in FIG. 1;

FIG. 4 is a diagram schematically illustrating an example of the configuration of the work machine according to the embodiment;

FIG. 5 is a top view of the inside of the driving room according to the embodiment;

FIG. 6 is a conceptual diagram illustrating a two-way conversation between an operator seated in the work machine according to the embodiment and a worker who exists around the work machine;

FIG. 7 is a diagram illustrating an example of a display screen displayed by a display device according to the embodiment;

FIGS. 8A and 8B are diagrams explaining an example of correcting the direction of speech in an output control part according to the embodiment;

FIG. 9 is a diagram illustrating an example of a display screen displayed by the display device according to the embodiment;

FIG. 10 is a diagram illustrating an example of a display screen displayed by the display device according to the embodiment;

FIG. 11 is a flowchart illustrating a processing procedure for displaying a direction of speech by a controller according to the embodiment;

FIG. 12 is a top view of another configuration example of a work machine according to another embodiment; and

FIG. 13 is a schematic view illustrating a configuration example of a remote support system for a work machine according to further another embodiment.

### DETAILED DESCRIPTION

When working in a work machine, there is a case where a person who exists near the work machine speaks to the person in the work machine. The sound detected by a microphone installed in the work machine is output from the speaker to the operator of the work machine. Thus, the operator can recognize the spoken content. However, because the operator of the work machine does not know the direction in which the person who spoke exists, there is a case where the operator of the work machine does not know how to respond.

Therefore, it is desirable to provide a technology for facilitating the identification of the person who spoke by reporting the direction of the speech and facilitating communication with the person who spoke.

According to an aspect of the present invention, communication with a person who has spoken is facilitated.

Embodiments of the present invention will be described below with reference to the drawings. The embodiments described below are exemplary rather than limiting the present invention, and all features and combinations thereof described in the embodiments are not necessarily essential to the present invention. In each of the drawings, the same or corresponding configurations are denoted by the same or corresponding reference numerals, and explanations may be omitted.

The work machine 100 according to the embodiment of the present disclosure is an excavator. The work machine 100 may be a machine other than an excavator such as a crane, an asphalt finisher, or a forklift. In the illustrated example, the excavator serving as the working machine 100 is an excavator provided with a bucket 6 as an end attachment, but it may be an application machine such as a forestry machine provided with an end attachment other than the bucket 6.

In the following description, the work machine 100 is an excavator provided with a bucket 6 as an end attachment, but the present invention is not limited to an excavator. The work machine 100 may be an application machine such as a forestry machine having an end attachment other than the bucket 6.

### First Embodiment

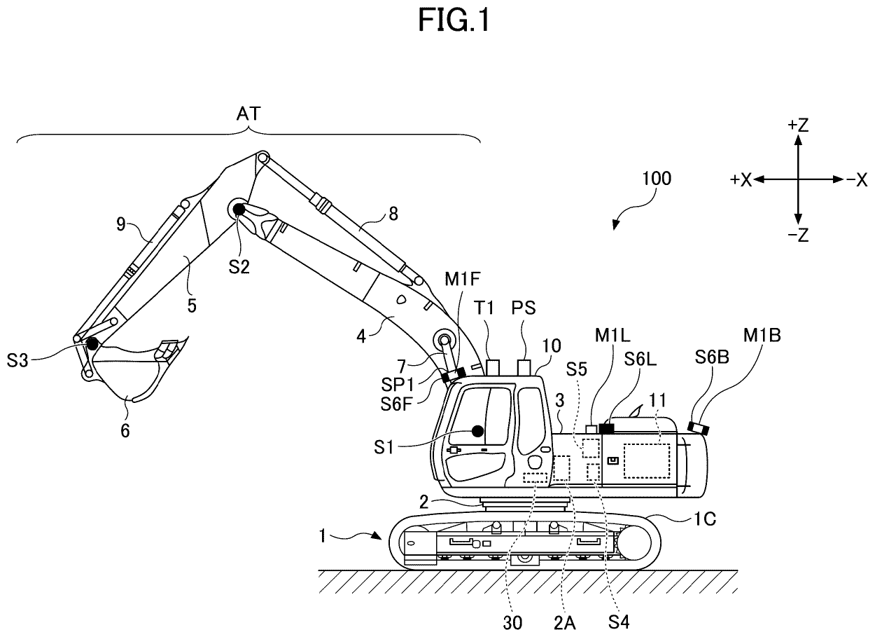

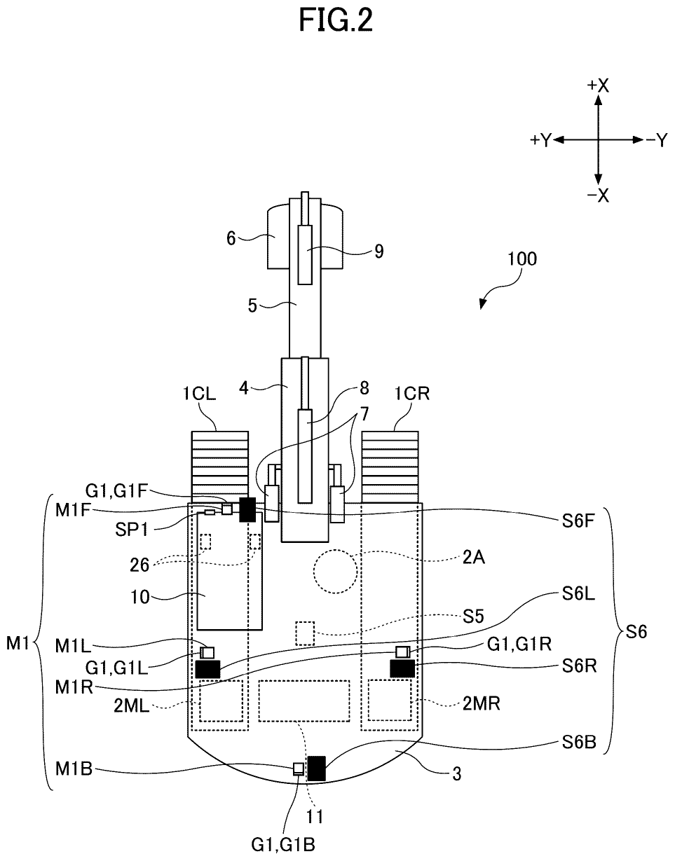

First, an outline of the work machine 100 will be described with reference to FIGS. 1 and 2. FIG. 1 is a side view of the work machine 100, and FIG. 2 is a top view of the work machine 100.

The work machine 100 is provided with a lower traveling body 1, an upper turning body 3 mounted on the lower traveling body 1 so as to be able to turn freely through a turning mechanism 2, an attachment AT for performing various kinds of work, and a driving room 10. The front side of the work machine 100 (the upper turning body 3) corresponds to the direction in which the attachment AT extends with respect to the upper turning body 3 when the work machine 100 is viewed from the top (top view) along the turning axis of the upper turning body 3. The left side and the right side of the work machine 100 (the upper turning body 3) correspond to the left side and the right side respectively, as viewed from the operator sitting on the driving seat in the driving room 10.

The lower traveling body 1 includes, for example, a pair of left and right crawlers 1C. Specifically, the crawlers 1C include a left crawler 1CL and a right crawler 1CR. The left crawler 1CL is driven by a left traveling hydraulic motor 2ML, and the right crawler 1CR is driven by a right traveling hydraulic motor 2MR. The left traveling hydraulic motor 2ML is a traveling driving part that drives the left crawler 1CL that is the driven part and can rotate the left crawler 1CL. The right traveling hydraulic motor 2MR is a traveling driving part that drives the right crawler 1CR that is the driven part and can rotate the right crawler 1CR. The traveling driving part may be an electric motor.

The upper turning body 3 turns with respect to the lower traveling body 1 when the turning mechanism 2 is driven by the turning hydraulic motor 2A. The turning hydraulic motor 2A is a turning driving part that drives the upper turning body 3 that is a driven part and can change the orientation of the upper turning body 3. The turning driving part may be an electric motor.

A boom 4 is rotatably attached to the front center of the upper turning body 3, an arm 5 is rotatably attached to the tip of the boom 4, and a bucket 6 is rotatably attached to the tip of the arm 5. In the illustrated example, the boom 4, the arm 5, and the bucket 6 constitute an excavation attachment which is an example of the attachment AT. The boom 4, the arm 5, and the bucket 6 are driven by a boom cylinder 7, an arm cylinder 8, and a bucket cylinder 9, respectively.

The bucket 6 is an example of a work tool (end attachment). The bucket 6 is used, for example, for excavation work. Other work tools may be attached to the tip of the arm 5 in place of the bucket 6 depending on the work content. Other work tools may be other types of buckets such as large buckets, slope buckets, and dredging buckets. The other work tools may be types of work tools other than a bucket, such as agitators, breakers, grapples, or lifting magnets.

The turning hydraulic motor 2A, the left traveling hydraulic motor 2ML, the right traveling hydraulic motor 2MR, the boom cylinder 7, the arm cylinder 8, and the bucket cylinder 9 are hydraulic actuators driven by hydraulic oil discharged from the hydraulic pump.

In the work machine 100, all or part of the driven parts such as the lower traveling body 1, the upper turning body 3, the boom 4, the arm 5, and the bucket 6 may be electrically driven. That is, the work machine 100 may be a hybrid excavator or an electric excavator in which all or part of the driven parts are driven by an electric actuator.

An information transmission device G1, an external sound collecting device M1, an imaging device S6, and an external sound output device SP1 are attached to the work machine 100.

The imaging device S6 is provided in the upper turning body 3 or the driving room 10, and captures the surrounding area of the work machine 100 and acquires image information representing the surrounding area of the work machine 100. In the illustrated example, the imaging device S6 includes a front camera S6F, a left camera S6L, a right camera S6R, and a rear camera S6B.

The front camera S6F is a camera for capturing an area in front of the work machine 100, and is mounted on the outside of the driving room 10, such as the roof of the driving room 10 or the side face of the boom 4. The front camera S6F may be mounted, for example, on the ceiling of the driving room 10, that is, inside of the driving room 10. The left camera S6L is a camera for capturing an area to the left of the work machine 100, the right camera S6R is a camera for capturing an area to the right of the work machine 100, and the rear camera S6B is a camera for capturing an area to the rear of the work machine 100. Specifically, the front camera S6F, the left camera S6L, the right camera S6R, and the rear camera S6B are all monocular wide-angle cameras equipped with imaging devices such as CCD or CMOS, and output the captured images to the display device D1. Information of the images captured by the imaging device S6 is taken into the controller 30.

In the illustrated example, the front camera S6F is mounted on the roof of the driving room 10, the left camera S6L is mounted on the left end of the upper surface of the upper turning body 3, the right camera S6R is mounted on the right end of the upper surface of the upper turning body 3, and the rear camera S6B is mounted on the rear end of the upper surface of the upper turning body 3.

The imaging device S6 may constitute an object detection device for detecting objects around the work machine 100. The object detection device may be constituted by a device other than a camera. For example, the object detection device may be a LiDAR. The LiDAR is a device that can measure the distance between a point group of 1 million or more points within the monitoring range and a LiDAR (laser source). The object detection device may be another device that can measure the distance to the object, such as a stereo camera, a distance image camera, or a millimeter-wave radar. When a millimeter-wave radar or the like is used as the object detection device, the object detection device may transmit a large number of signals (such as laser beams) toward the object and receive the reflected signals to derive the distance and direction of the object. Alternatively, the object detection device may be a combination of two or more types of devices. For example, the object detection device may be a combination of an imaging device and a LiDAR, a combination of an imaging device and a millimeter-wave radar, or a combination of an imaging device and a stereo camera.

The external sound collecting device M1 is a device that collects external sound and is also referred to as a microphone. In the illustrated example, the external sound collecting device M1 is provided in the upper turning body 3 or the driving room 10, and converts sound (air vibration) generated around the work machine 100 into mechanical vibration, and converts the mechanical vibration into electrical signals. Specifically, the external sound collecting device M1 includes a front microphone M1F, a left microphone M1L, a right microphone M1R, and a rear microphone M1B.

The front microphone M1F is a microphone that collects sound generated in front of the work machine 100, and is mounted on the outside of the driving room 10, such as the roof of the driving room 10 and the side surface of the boom 4. The front microphone M1F may be mounted, for example, on the ceiling of the driving room 10, that is, inside of the driving room 10. The left microphone M1L collects sound generated in the left side of the work machine 100, the right microphone M1R collects sound generated on the right side of the work machine 100, and the rear microphone M1B collects sound generated at the rear of the work machine 100. The electric signals generated by the front microphone M1F, the left microphone M1L, the right microphone M1R, and the rear microphone M1B are taken into the controller 30.

In the illustrated example, the front microphone M1F is mounted on the roof of the driving room 10, the left microphone M1L is mounted on the left end of the upper surface of the upper turning body 3, the right microphone M1R is mounted on the right end of the upper surface of the upper turning body 3, and the rear microphone M1B is mounted on the rear end of the upper surface of the upper turning body 3. Thus, the four external sound collecting devices M1 (the front microphone M1F, the left microphone M1L, the right microphone M1R, and the rear microphone M1B) are provided at different positions of the upper turning body 3. Therefore, the controller 30 can detect the direction that is toward the sound source based on the difference (for example, differences in volume) among the sounds collected by the four external sound collecting devices M1. When an array microphone is used as the external sound collecting device M1, the direction in which the sound source is located can be detected based on, for example, a phase shift or a difference in volume.

In the illustrated example, each of the four external sound collecting devices M1 and each of the four imaging devices S6 are arranged so as to correspond to each other. Specifically, the front microphone M1F is arranged so as to be adjacent to the front camera S6F, the left microphone M1L is arranged so as to be adjacent to the left camera S6L, the right microphone M1R is arranged so as to be adjacent to the right camera S6R, and the rear microphone M1B is arranged so as to be adjacent to the rear camera S6B.

The external sound output device SP1 outputs sound toward the surrounding area of the work machine 100. In the illustrated example, the external sound output device SP1 is a non-directional speaker and is configured so as to output sound uniformly in all directions. However, the external sound output device SP1 may be a directional speaker which outputs sound toward the front.

The information transmission device G1 informs the outside of the work machine 100 of the state of the work machine 100. In the illustrated example, the information transmission device G1 is provided in the upper turning body 3 or the driving room 10, and is configured so as to be able to transmit the state of the work machine 100 to the worker around the work machine 100. Specifically, the information transmission device G1 includes a front light bar G1F, a left light bar G1L, a right light bar G1R, and a rear light bar G1B.

The front light bar G1F is a light emitting device capable of visually transmitting information to the worker or the like in front of the work machine 100, and is attached to the outside of the driving room 10, such as the roof of the driving room 10 or the side of the boom 4. The front light bar G1F may be attached, for example, to the ceiling of the driving room 10, that is, to the inside of the driving room 10. The left light bar G1L is a light emitting device capable of visually transmitting information to the worker or the like at the left side of the work machine 100, the right light bar G1R is a light emitting device capable of visually transmitting information to the worker or the like at the right side of the work machine 100, and the rear light bar G1B is a light emitting device capable of visually transmitting information to the worker or the like at the rear of the work machine 100. Each of the front light bar G1F, the left light bar G1L, the right light bar G1R, and the rear light bar G1B emits light in response to an electric signal from the controller 30. In the illustrated example, the light emitting device is an LED light, but other light emitting devices such as a halogen lamp may be used. The light emitting device is a multicolor light emitting type, but may be a monochromatic light emitting type.

In the illustrated example, the front light bar G1F is attached to the roof of the driving room 10, the left light bar G1L is attached to the left end of the upper surface of the upper turning body 3, the right light bar G1R is attached to the right end of the upper surface of the upper turning body 3, and the rear light bar G1B is attached to the rear end of the upper surface of the upper turning body 3. Thus, the four information transmission devices G1 (the front light bar G1F, the left light bar G1L, the right light bar G1R, and the rear light bar G1B) are provided at different positions of the upper turning body 3. Therefore, by operating each of the four information transmission devices G1 separately, the controller 30 can convey the state of the work machine 100 to the workers at the front, left, right, and rear areas of the work machine 100.

In the illustrated example, each of the four information transmission devices G1 and each of the four external sound collecting devices M1 are arranged so as to correspond to each other. Specifically, the front light bar G1F is arranged so as to be adjacent to the front microphone M1F, the left light bar G1L is arranged so as to be adjacent to the left microphone M1L, the right light bar G1R is arranged so as to be adjacent to the right microphone M1R, and the rear light bar G1B is arranged so as to be adjacent to the rear microphone M1B.

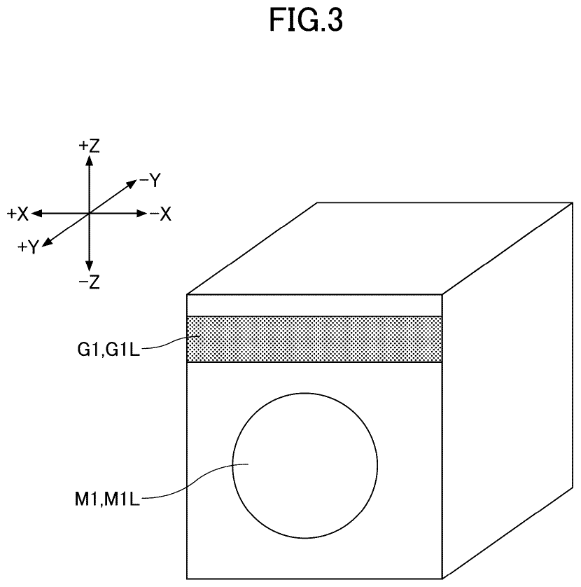

FIG. 3 is a diagram illustrating an example of the configuration of the external sound collecting device M1 and the information transmission device G1 attached to the work machine 100. Specifically, FIG. 3 is a perspective view of the left microphone M1L and the left light bar G1L attached to the substantially rectangular parallelepiped housing. Although the following description referring to FIG. 3 relates to the combination of the left microphone M1L and the left light bar G1L, the same applies to the combination of the front microphone M1F and the front light bar G1F, the combination of the right microphone M1R and the right light bar G1R, and the combination of the rear microphone M1B and the rear light bar G1B.

As illustrated in FIG. 3, the left microphone M1L and the left light bar G1L are arranged on the left side of the substantially rectangular parallelepiped housing so as to face the area to the left side of the work machine 100. With this arrangement, the left microphone M1L can efficiently collect sounds generated on the left side of the work machine 100, and the left light bar G1L can efficiently convey the state of the work machine 100 to the worker on the left side of the work machine 100. For example, the left microphone M1L can capture the voice spoken by the worker on the left side of the work machine 100, and the left light bar G1L can convey to the worker that the left microphone M1L has captured the voice of the worker by emitting light in a predetermined color. In this case, the worker on the left side of the work machine 100 who has spoken to the left microphone M1L can confirm that his or her voice has reached the left microphone M1L (i.e., the operator of the work machine 100) by seeing the left light bar G1L emitting light in a predetermined color.

The information transmission device G1 may be provided at the top of each of the four sides of the driving room 10. For example, the information transmission device G1 may be configured such that the front light bar G1F is attached to the top of the front face of the driving room 10, the left light bar G1L is attached to the top of the left face of the driving room 10, the right light bar G1R is attached to the top of the right face of the driving room 10, and the rear light bar G1B is attached to the top of the rear face of the driving room 10. Further, the information transmission device G1 may be a rotating lamp such as a NICO TORCH attached to the top of the driving room 10, or a display device such as a liquid crystal display or an organic EL display.

The controller 30 is an example of a control device and is composed of a computer including, for example, a CPU, a volatile storage device, a nonvolatile storage device, and various input/output interfaces. Then, the controller 30 implements various functions by, for example, reading a program from the nonvolatile storage device, loading the program into the volatile storage device, and causing the CPU to execute the program. In the illustrated example, the controller 30 is configured to implement various functions and control the work machine 100. The various functions include, for example, a machine guidance function for guiding the manual operation of the work machine 100 by an operator. The various functions may include a contact avoidance function for automatically or autonomously operating or stopping the work machine 100 in order to avoid contact between the work machine 100 and an object existing within the monitoring range around the work machine 100.

The boom angle sensor S1 detects the boom angle which is the rotation angle of the boom 4 with respect to the upper turning body 3. The arm angle sensor S2 detects the arm angle which is the rotation angle of the arm 5 with respect to the boom 4. The bucket angle sensor S3 detects the bucket angle which is the rotation angle of the bucket 6 with respect to the arm 5.

Each of the boom angle sensor S1, the arm angle sensor S2, and the bucket angle sensor S3 may be, for example, a rotary encoder, an acceleration sensor, a 6-axis sensor, an IMU (inertial measurement unit), etc., a potentiometer using a variable resistor, a cylinder stroke sensor for detecting the stroke amount of a hydraulic cylinder, etc.

A detection signal corresponding to the boom angle acquired by the boom angle sensor S1, a detection signal corresponding to the arm angle acquired by the arm angle sensor S2, and a detection signal corresponding to the bucket angle acquired by the bucket angle sensor S3 are taken into the controller 30.

The body inclination sensor S4 detects the inclined state of the body (the lower traveling body 1 or the upper turning body 3) with respect to the horizontal plane. The body inclination sensor S4 is attached to the upper turning body 3, for example, and detects the inclination angle of the work machine 100 (that is, the upper turning body 3) around two axes respectively in the longitudinal direction and the lateral direction. The body inclination sensor S4 may be, for example, an acceleration sensor, a 6-axis sensor, or an IMU. The detection signal corresponding to the inclination angle detected by the body inclination sensor S4 is taken into the controller 30.

The turning sensor S5 outputs information related to the turning of the upper turning body 3. The turning sensor S5 detects, for example, the turning angle speed of the upper turning body 3 relative to the lower traveling body 1. The turning sensor S5 may detect the turning angle. The turning sensor S5 may be, for example, a gyro sensor, a resolver, or a rotary encoder. A detection signal corresponding to the turning angle or turning angle speed of the upper turning body 3 detected by the turning sensor S5 is taken into the controller 30.

The positioning device PS measures the position of the upper turning body 3. The positioning device PS may be, for example, a GNSS (Global Navigation Satellite System) compass, and detects the position and orientation of the upper turning body 3. A detection signal corresponding to the position and orientation of the upper turning body 3 is taken into the controller 30. The function of detecting the orientation of the upper turning body 3 may be implemented by a direction sensor attached to the upper turning body 3.

The driving room 10 is a cabin where the operator is seated, and is mounted on the front left side of the upper turning body 3. However, the driving room 10 may be omitted in a case where the work machine 100 is operated remotely or in a case where the work machine 100 is operated by fully automatic operation.

The communication device T1 communicates with external equipment through a communication network including a mobile communication network, a satellite communication network, or an Internet network. The communication device T1 may be, for example, a mobile communication module corresponding to a mobile communication standard such as LTE (Long Term Evolution), 4G (4th Generation), 5G (5th Generation), etc., or a satellite communication module for connecting to a satellite communication network.

The work machine 100 operates actuators in response to the operation of an operator seated in the driving room 10 to drive driven parts such as the lower traveling body 1, the upper turning body 3, the boom 4, the arm 5, and the bucket 6.

Alternatively, the work machine 100 may be configured to be remotely operated from the outside of the work machine 100. When the work machine 100 is remotely operated, the inside of the driving room 10 may be in an unmanned state.

Further, the work machine 100 may automatically operate the actuator regardless of the operation of the operator. Thus, the work machine 100 implements the function of automatically operating at least a part of the driven parts such as the lower traveling body 1, the upper turning body 3, the boom 4, the arm 5, and the bucket 6, that is, what is referred to as a “machine control function”.

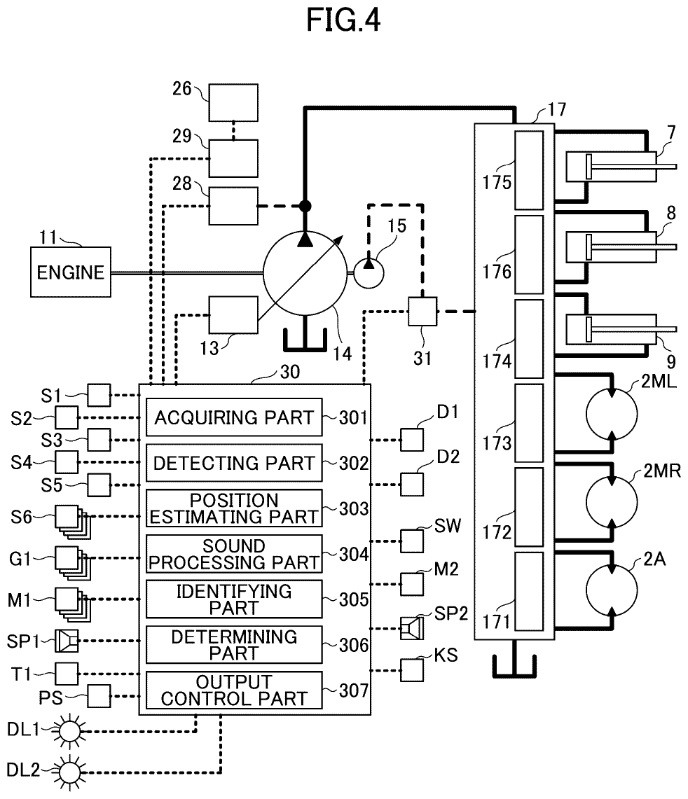

FIG. 4 schematically illustrates an example of the configuration of the work machine 100. In FIG. 4, the mechanical power transmission system, the hydraulic oil line, the pilot line, and the electric control system are indicated by double lines, bold solid lines, bold dashed lines, and dotted lines, respectively.

The driving system of the work machine 100 includes an engine 11, a regulator 13, a main pump 14, and a control valve unit 17. The hydraulic driving system of the work machine 100 includes hydraulic actuators such as the turning hydraulic motor 2A, the left traveling hydraulic motor 2ML, the right traveling hydraulic motor 2MR, the boom cylinder 7, the arm cylinder 8, and the bucket cylinder 9.

The engine 11 is an example of a power source of the work machine 100 and is mounted, for example, at the rear of the upper turning body 3. The power source of the work machine 100 may be a combination of a power source such as a battery or a fuel cell and an electric motor. Specifically, the engine 11 constantly rotates at a predetermined target rotation speed under direct or indirect control by the controller 30 to drive the main pump 14 and the pilot pump 15. The engine 11 is, for example, a diesel engine using light oil as fuel. The engine 11 may be a gasoline engine or a hydrogen engine.

The regulator 13 controls the discharge amount of the main pump 14. For example, the regulator 13 controls the discharge amount of the main pump 14 by adjusting the angle (tilt angle) of the swash plate of the main pump 14 in response to a control instruction from the controller 30.

The main pump 14, for example, like the engine 11, is mounted at the rear of the upper turning body 3 and supplies hydraulic oil to the control valve unit 17 through a hydraulic oil line. In the illustrated example, the main pump 14 is a variable displacement hydraulic pump.

The control valve unit 17 is a hydraulic control device for controlling the hydraulic system in the work machine 100. In the illustrated example, the control valve unit 17 includes control valves 171 to 176. The control valve unit 17 is configured to selectively supply hydraulic oil discharged from the main pump 14 to one or more hydraulic actuators through the control valves 171 to 176. The control valves 171 to 176 control the flow rate of hydraulic oil flowing from the main pump 14 to the hydraulic actuator and the flow rate of hydraulic oil flowing from the hydraulic actuator to the hydraulic oil tank. The hydraulic actuator includes the boom cylinder 7, the arm cylinder 8, the bucket cylinder 9, the left traveling hydraulic motor 2ML, the right traveling hydraulic motor 2MR, and the turning hydraulic motor 2A. Specifically, the control valve 171 corresponds to the left traveling hydraulic motor 2ML, the control valve 172 corresponds to the right traveling hydraulic motor 2MR, and the control valve 173 corresponds to the turning hydraulic motor 2A. The control valve 174 corresponds to the bucket cylinder 9, the control valve 175 corresponds to the boom cylinder 7, and the control valve 176 corresponds to the arm cylinder 8.

The pilot pump 15 is an example of a pilot pressure generating device, and is configured to supply hydraulic oil to the hydraulic control equipment via a pilot line. In the illustrated example, the pilot pump 15 is a fixed-capacity hydraulic pump. However, the pilot pressure generating device may be implemented by the main pump 14. That is, the main pump 14 may have a function of supplying hydraulic oil to the control valve unit 17 via a hydraulic oil line and a function of supplying hydraulic oil to various hydraulic control equipment via a pilot line. In this case, the pilot pump 15 may be omitted.

The discharge pressure sensor 28 is configured to detect the discharge pressure of the main pump 14. In the example illustrated in the figure, the discharge pressure sensor 28 outputs the detected value to the controller 30.

An operation device 26 is a device used by an operator to operate an actuator. The operation device 26 includes, for example, an operating lever and an operating pedal. The actuator may be a hydraulic actuator or an electric actuator.

The operating sensor 29 is configured to detect the operation contents of an operator using the operation device 26. In the present embodiment, the operating sensor 29 detects the operating direction and the operating amount of the operation device 26 corresponding to each of the actuators, and outputs the detected values to the controller 30. In the illustrated example, the controller 30 can control the opening area of the proportional valve 31 according to the output of the operating sensor 29. Then, the controller 30 supplies the hydraulic oil discharged from the pilot pump 15 to the pilot port of the corresponding control valve in the control valve unit 17. The pressure (pilot pressure) of the hydraulic oil supplied to each of the pilot ports is, in principle, the pressure corresponding to the operating direction and the operating amount of the operation device 26 corresponding to each of the hydraulic actuators. Thus, the operation device 26 is configured to supply the hydraulic oil discharged from the pilot pump 15 to the pilot port of the corresponding control valve in the control valve unit 17.

The proportional valve 31, which functions as a control valve for machine control, is arranged in a pipe line connecting the pilot pump 15 and the pilot port of the control valve in the control valve unit 17, and is configured such that the flow area of the pipe line can be changed. In the illustrated example, the proportional valve 31 operates according to a control instruction output from the controller 30. Therefore, the controller 30 can adjust the pilot pressure acting on the pilot port of the control valve by the proportional valve 31 regardless of the operation of the operation device 26 by the operator.

With this configuration, the controller 30 can operate the hydraulic actuator corresponding to the specific operation device 26 even when the operation of the specific operation device 26 is not performed.

The control system of the work machine 100 includes a controller 30, a display device D1, an input device D2, a speech button KS, an external sound collecting device (an example of a sound collecting device) M1, an internal sound collecting device M2, an external sound output device SP1, an internal sound output device SP2, an external volume dial DL1, an internal volume dial DL2, a switch SW, and a communication device T1.

The controller 30 is configured to output a control instruction to the regulator 13 as needed to change the discharge amount of the main pump 14.

The controller 30 may be configured to control, for example, the machine guidance function for guiding the manual operation of the work machine 100 by an operator through the operation device 26. The controller 30 may be configured to control, for example, the machine control function for automatically supporting the manual operation of the work machine 100 by an operator through the operation device 26.

Note that some of the functions of the controller 30 may be implemented by other controllers (control devices). That is, the functions of the controller 30 may be implemented in a manner that they are distributed among a plurality of controllers. For example, the machine guidance function and the machine control function may be implemented by an exclusive-use controller (control device).

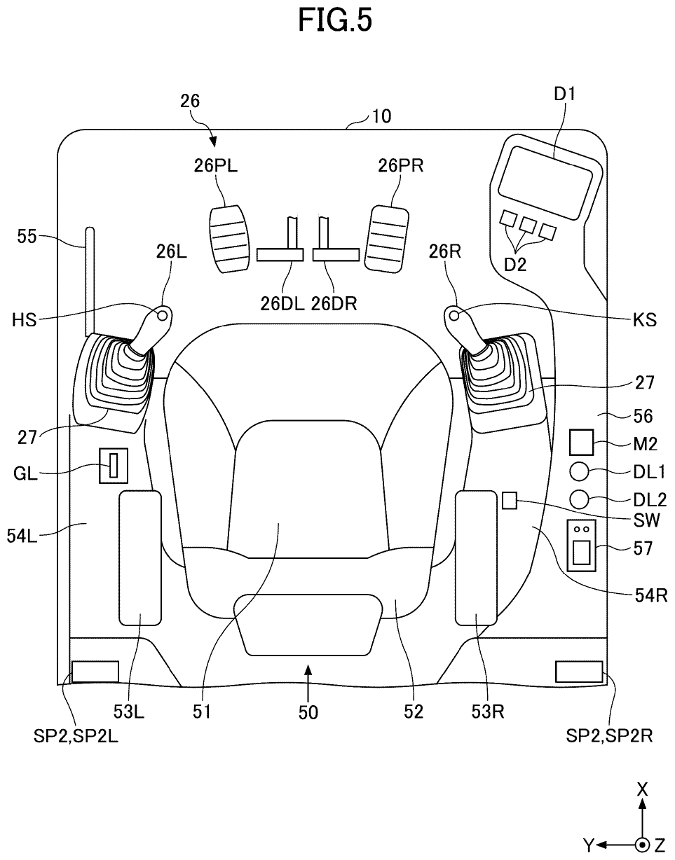

Referring now to FIG. 5, the inside of the driving room 10 will be described. FIG. 5 is a top view of the inside of the driving room 10. The work machine 100 includes a driving seat 50, the operation device 26, a display device D1, and the like, which are arranged inside the driving room 10. An access door is provided on the left side of the driving seat 50. The operator can enter the inside of the driving room 10 by opening the access door.

The driving seat 50 is arranged in the center of the driving room 10 in the top view. The driving seat 50 includes a seat 51 on which the operator sits and a backrest 52. The driving seat 50 is a reclining seat, and the inclination angle of the backrest 52 is adjustable. A left armrest 53L is arranged on the left side of the driving seat 50, and a right armrest 53R is arranged on the right side. The left armrest 53L and the right armrest 53R are rotatably supported by the backrest 52.

A left console 54L is arranged on the left side of the driving seat 50, and a right console 54R is arranged on the right side. The left console 54L and the right console 54R extend along the longitudinal direction. The driving seat 50 is slidable in the longitudinal direction. The driving seat 50 may be slidable in the longitudinal direction together with the left console 54L and the right console 54R.

The left armrest 53L is arranged on the left console 54L. The right armrest 53R is arranged on the right console 54R. The left armrest 53L is arranged so as to cover a part of the left console 54L in the top view. The right armrest 53R is arranged so as to cover a part of the right console 54R in the top view.

The operation device 26 includes a left operation lever 26L, a right operation lever 26R, a left traveling pedal 26PL, a right traveling pedal 26PR, a left traveling lever 26DL, and a right traveling lever 26DR.

The left operation lever 26L is provided at the front of the left console 54L. Similarly, the right operation lever 26R is provided at the front of the right console 54R. An operator seated on the driving seat 50 can operate the left operation lever 26L while holding the left operation lever 26L with his left hand, and can operate the right operation lever 26R while holding the right operation lever 26R with his right hand. An operator seated on the driving seat 50 can operate the left operation lever 26L with his left hand to drive the arm cylinder 8 and the turning hydraulic motor 2A. An operator seated on the driving seat 50 can operate the right operation lever 26R with his right hand to drive the boom cylinder 7 and the bucket cylinder 9. The bases of the left operation lever 26L and the right operation lever 26R are covered with lever boots 27.

The left traveling pedal 26PL and the right traveling pedal 26PR are arranged on the floor in front of the driving seat 50. An operator seated on the driving seat 50 can operate the left traveling pedal 26PL with his left foot to drive the left traveling hydraulic motor 2ML. The operator seated on the driving seat 50 can operate the right traveling pedal 26PR with his right foot to drive the right traveling hydraulic motor 2MR.

The left traveling lever 26DL and the right traveling lever 26DR are arranged between the left traveling pedal 26PL and the right traveling pedal 26PR in the top view. The left traveling lever 26DL and the right traveling lever 26DR extend upward from the floor surface in front of the driving seat 50. The operator seated on the driving seat 50 can drive the left traveling hydraulic motor 2ML in the same manner as the operation through the left traveling pedal 26PL by gripping the left traveling lever 26DL with his left hand. The operator seated on the driving seat 50 can drive the right traveling hydraulic motor 2MR in the same manner as the operation through the right traveling pedal 26PR by gripping the right traveling lever 26DR with his right hand. The left traveling lever 26DL and the right traveling lever 26DR are arranged such that the operator can simultaneously operate the left traveling lever 26DL and the right traveling lever 26DR with one hand.

The display device D1 is arranged in front of the right side of the driving seat 50. The display device D1 displays various kinds of image information. The display device D1 includes a display screen for displaying information such as working conditions or operating conditions of the work machine 100. An operator seated on the driving seat 50 can perform work with the work machine 100 while confirming various kinds of information displayed on the display device D1. The display device D1 may be provided with an input device D2.

The input device D2 is provided within reach of the operator seated in the driving room 10, receives various operation inputs by the operator, and outputs signals corresponding to the operation inputs to the controller 30. The input device D2 includes a touch panel mounted on the display of the display device D1 for displaying various information images, a knob switch provided at the tip of one or more of the plurality of operation levers included in the operation device 26, or a button switch, a lever, a toggle switch, or a rotary dial provided around the display device D1. A signal corresponding to the contents of the operation to the input device D2 is taken into the controller 30.

A gate bar 55 is attached to the front of the front end of the left console 54L. The gate bar 55 operates in conjunction with the operation state of the gate lock lever GL provided in the left console 54L. The gate bar 55 is mounted on an inner frame of the left console 54L in a liftable manner around the axis in the lateral direction of the upper end.

The gate lock lever GL is a mechanical input operation part for switching between a state in which operation of the work machine 100 by the operation device 26 is possible (operable state) and a state in which operation of the work machine 100 by the operation device 26 is not possible (inoperable state). In the illustrated example, the gate lock lever GL is configured such that an operator can switch between a first operation position to implement the inoperable state and a second operation position to implement the operable state. The controller 30 switches between an operable state and an inoperable state according to the operation state of the gate lock lever GL. In the illustrated example, the controller 30 switches between an operable state and an inoperable state of the work machine 100 by electrically switching between communication and non-communication of the pilot line according to the operation state of the gate lock lever GL.

Further, when the gate lock lever GL is in the second operation position, the gate bar 55 is in a state in which it is raised forward so as to prevent the operator from passing through the access door (passage prohibition state), as illustrated in FIG. 5. On the other hand, when the gate lock lever GL is in the first operation position, the gate bar 55 is in a state in which it is housed inside the left console 54L (passage permission state) so as not to prevent the operator from passing through the access door.

With this configuration, the operator cannot operate the work machine 100 unless the gate lock lever GL is set to the second operating position and the gate bar 55 is set to the passage prohibition state. Therefore, this configuration can prevent the work machine 100 from moving unintentionally even if the operator inadvertently touches the operation device 26 when getting on and off. Therefore, this configuration can improve the safety of the work machine 100.

Further, the work machine 100 may be configured to accept a predetermined operation for starting the engine 11 only when the gate lock lever GL is set to the second operating position and the gate bar 55 is set to the passage prohibition state. That is, the work machine 100 may be configured not to start the engine 11 when the gate lock lever GL is set to the first operating position and the gate bar 55 is set to the passage permission state.

A switch SW is installed in the right console 54R. A window side console 56 is installed on the right side of the right console 54R. The window side console 56 extends over the entire length in the longitudinal direction of the driving room 10 and is provided in parallel with the right console 54R. The display device D1 is installed at the front of the window side console 56. The window side console 56 is installed with an external volume dial DL1, an internal volume dial DL2, and an internal sound collecting device M2.

Further, the window side console 56 is installed with a radio tuner 57 or the like. The radio tuner 57 or the like may be installed in the left console 54L or the right console 54R.

The radio tuner 57 is provided with a switch. On/off control of the radio and adjustment control of the volume can be performed in response to pressing of the switch and rotation operation of the switch. Further, the operation for controlling the radio tuner 57 is not limited to the operation of the physically provided switch, but may be performed by using a touch panel (of the input device D2) provided in the display device D1. For example, the controller 30 may perform on/off control of the radio tuner 57 and adjustment control of the volume by accepting the operation of the touch panel. The volume adjustment of the radio tuner 57 may be made independent of the volume adjustment of the external voice (the voice of the worker output in the vehicle) or may be made integrally adjustable.

The internal sound collecting device M2 is a device for collecting sounds generated in the driving room 10. In the illustrated example, the internal sound collecting device M2 is an indoor microphone and is configured to pick up voices emitted by the operator in the driving room 10.

The horn button HS is a button operated by the operator of the work machine 100 when the horn is sounded. In the illustrated example, the horn button HS is a knob switch provided at the tip of the left operation lever 26L.

The speech button KS is a button operated by the operator of the work machine 100 when the operator of the work machine 100 speaks to a worker around the work machine 100. In the illustrated example, the speech button KS is a knob switch provided at the tip of the right operation lever 26R.

The internal sound output device SP2 is a device for outputting sound to an operator in the driving room 10 and is provided in the driving room 10. The internal sound output device SP2 converts an electric signal input from the controller 30 into a physical sound (vibration of air) and outputs the sound. The internal sound output device SP2 may be provided at any position, for example, near the display device D1, near the input device D2, or near the door of the driving room 10. In the illustrated example, the internal sound output device SP2 includes a left indoor speaker SP2L attached to the upper left corner of the rear wall of the driving room 10 and a right indoor speaker SP2R attached to the upper right corner of the rear wall of the driving room 10. The internal sound output device SP2 may be a headphone or earphone worn by an operator. In this case, the headphone or earphone is connected so as to be able to communicate with the controller 30 via, for example, Bluetooth (registered trademark).

The external volume dial DL1 is configured to adjust the volume of sound output by the external sound output device SP1. Further, the volume of sound output by each of the external sound output devices SP1 may be additionally configured to make adjustments by using a device other than the external volume dial DL1, such as a touch panel attached to the display device D1.

The external volume dial DL1 may be configured to rotate indefinitely in the clockwise and counterclockwise directions. This is to address a case where volume adjustment using the external volume dial DL1 and volume adjustment using a device other than the external volume dial DL1 are used together.

The internal volume dial DL2 is configured to adjust the volume of sound output by the internal sound output device SP2. Further, the volume of sound output by each of the internal sound output devices SP2 may be additionally configured to make adjustments by using a device other than the internal volume dial DL2, such as a touch panel attached to the display device D1.

The internal volume dial DL2 may be configured to rotate infinitely in both clockwise and counterclockwise directions. This is to address a case where volume adjustment using the internal volume dial DL2 and volume adjustment using a device other than the internal volume dial DL2 are used together.

The storage device 35 is provided, for example, in the driving room 10 and stores various kinds of information under the control of the controller 30. The storage device 35 is, for example, a nonvolatile storage medium such as a semiconductor memory. The storage device 35 stores information for preventing the output of sound from the internal sound output device SP2. The storage device 35 may store, for example, data related to the target work surface acquired through the communication device T1 or set through the input device D2. The target work surface may be set (stored) by the operator of the work machine 100 or set by a work manager or the like.

The switch SW is a switch for switching whether or not to operate the sound output function for outputting the sound collected by the external sound collecting device M1 from the internal sound output device SP2. In the illustrated example, the switch SW is provided on the upper surface of the right console 54R. However, the switch SW may be one of the input devices D2, may be implemented by a touch panel provided on the display device D1, or may be a knob switch.

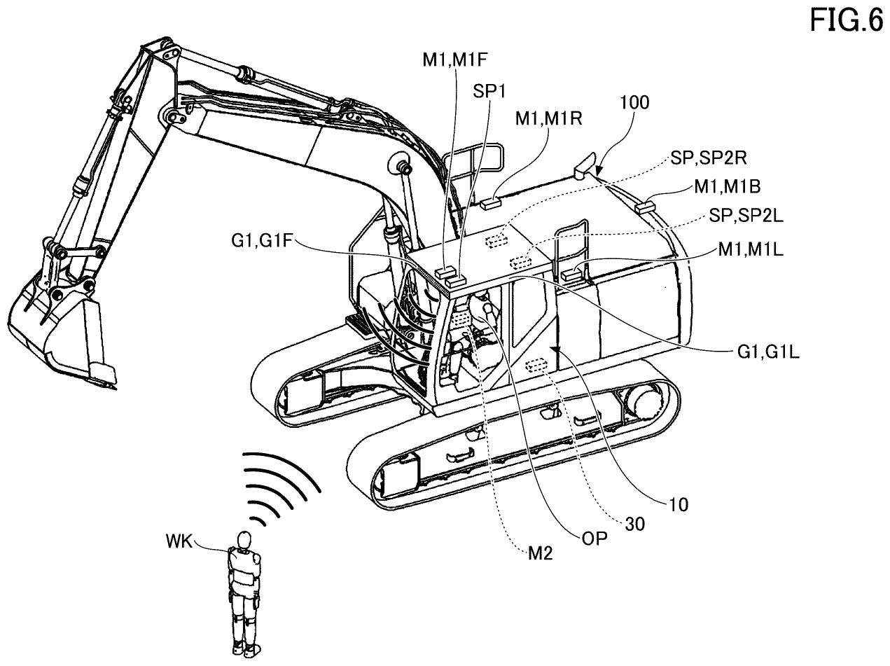

A conversation function is a function for implementing a conversation between an operator OP of the work machine 100 and a worker WK around the work machine 100 as illustrated in FIG. 6. FIG. 6 is a perspective view of the work machine 100 in which the operator OP is seated and the worker WK on the left front side of the work machine 100. FIG. 6 illustrates how the voice of the operator OP is collected by the internal sound collecting device M2 and output from the external sound output device SP1, and the voice of the worker WK is collected by the external sound collecting device M1 and output from the internal sound output device SP2. In the work machine 100 illustrated in FIG. 6, the information transmission device G1 is provided at the top of each of the four sides of the driving room 10. The front light bar G1F provided at the top of the front face of the driving room 10 emits green light, and the left light bar G1L provided at the top of the left face of the driving room 10 emits white light. In FIG. 6, a dot pattern is attached to the front light bar G1F that emits green light. When the worker WK sees the front light bar G1F that emits green light, the worker WK can recognize that his/her voice is detected by the front microphone M1F. In FIG. 6, other devices such as the imaging device S6 are not illustrated for clarity.

The operating state of the conversation function includes an on state (state illustrated in FIG. 6) in which a conversation between the operator OP and the worker WK is possible, and an off state in which a conversation between the operator OP and the worker WK is not possible. However, the operating state of the conversation function may additionally include at least one of an audible state (relating to the operator OP) in which the operator OP can hear the voice of the worker WK but the worker WK cannot hear the voice of the operator OP and a speech-enabled state (relating to the operator OP) in which the worker WK can hear the voice of the operator OP but the operator OP cannot hear the voice of the worker WK.

Specifically, when the operating state of the conversation function is switched to the ON state by operating the switch SW, the external sound collecting device M1, the external sound output device SP1, the internal sound collecting device M2, and the internal sound output device SP2 become available for use. On the other hand, when the operating state of the conversation function is switched to the OFF state by operating the switch SW, the external sound collecting device M1, the external sound output device SP1, the internal sound collecting device M2, and the internal sound output device SP2 become unavailable for use. When the operating state of the conversation function is switched to the audible state by operating the switch SW, the external sound collecting device M1 and the internal sound output device SP2 become available for use. When the operating state of the conversation function is switched to the speech-enabled state by operating the switch SW, the external sound output device SP1 and the internal sound collecting device M2 become available for use. In the illustrated example, the operator OP can speak to the worker WK using the external sound output device SP1 by speaking while pressing the speech button KS while the internal sound collecting device M2 is available for use.

Under the control of the controller 30 according to the present embodiment, the internal sound output device SP2 provided inside the driving room 10 outputs the sound collected by the external sound collecting device M1, and the external sound output device SP1 provided outside the driving room 10 outputs the sound collected by the internal sound collecting device M2. The controller 30 can switch between the output of the sound from the internal sound output device SP2 and the output of the sound from the external sound output device SP1 according to the operation of the operator OP, thereby implementing a two-way conversation. The controller 30 according to the present embodiment can prevent the simultaneous output of sound from the internal sound output device SP2 and the external sound output device SP1 by performing switching control of sound output according to the operation, and can prevent the occurrence of howling or the like. In the present embodiment, the method of performing the switching control is not limited, and the output of sound from the external sound output device SP1 and the internal sound output device SP2 may be performed simultaneously.

When the controller 30 simultaneously outputs the sound collected by the external sound collecting device M1 from the internal sound output device SP2 provided inside the driving room 10 and outputs the sound collected by the internal sound collecting device M2 from the external sound output device SP1 provided outside the driving room 10, the sound output from the sound output devices SP1 and SP2 may be collected by the sound collecting devices M2 and M1, resulting in the occurrence of echoes (reverberation) like an “echo among the hills”. Therefore, the controller 30 may execute an echo cancellation function for the sound indicated by the sound signal obtained from the external sound collecting device M1 or the internal sound collecting device M2. The echo cancellation function may be a function of eliminating echoes, for example, an echo suppressor system may be used to prevent one person's voice from being picked up while the other person's voice is being heard, or an echo canceller system may be used to eliminate echoes (reverberation) collected by the sound collecting devices M2 and M1. Further, any method may be used for the echo cancellation function, regardless of the well-known method described above.

### [Functional Configuration of Controller]

A configuration for the controller 30 to perform control based on the detected person will be described below. The controller 30 includes an acquiring part 301, a detecting part 302, a position estimating part 303, a sound processing part 304, an identifying part 305, a determining part 306, and an output control part 307 as machine guidance functions and machine control functions.

The acquiring part 301 acquires detection results from various sensors provided in the work machine 100. For example, the acquiring part 301 acquires image information indicating an imaging result from the imaging device S6. The acquiring part 301 also acquires sound signals representing sounds generated around the work machine 100 from the external sound collecting device M1.

The detecting part 302 performs detection processing of a person existing around the work machine 100 from the image information acquired by the acquiring part 301. Any method may be used for the detection processing of a person, regardless of the well-known method. For example, it may be determined whether or not the feature quantity extracted from the image information approximates the feature quantity indicating a person by a predetermined value or more.

When a person is detected by the detecting part 302, the position estimating part 303 estimates the position of the person in the real space, for example, the direction and distance where the person exists with reference to the work machine 100. For example, the position estimating part 303 may estimate the direction and distance where the person exists based on the position and size of the person in the image information. Further, when a LiDAR, a distance image camera, or a millimeter wave radar is mounted as the object detection device other than the imaging device S6, the direction and distance where the person exists may be estimated based on the detection result obtained by the object detection device. The position estimating part 303 according to the present embodiment acquires the direction and distance where the person exists with reference to the work machine 100 as the position information of the person around the work machine 100. However, the position information of the person is not limited to the direction and distance where the person exists with reference to the work machine 100, and information indicating the position coordinates of the person in the world coordinate system may be acquired, for example.

In the present embodiment, the detection of the person and the estimation of the position of the person are not limited to the above-described method, and the detection of the person and the estimation of the position (for example, the direction and distance) of the person may be performed by using a learned model.

The sound processing part 304 performs an emphasizing process on the band of the person's voice with respect to the sound signal acquired by the acquiring part 301, and performs a reduction process on the band other than the band of the person's voice. As the processing, a well-known method may be used, and for example, a noise canceling process may be performed, or the band other than the band of the person's voice may be prevented by a band bus filter or the like. Specifically, as the noise canceling process, the sound processing part 304 performs a process of preventing the sound generated from the work machine 100 such as the engine 11 based on the sound signals from the plurality of external sound collecting devices M1. Because the sound generated from the work machine 100 is prevented, the operator can easily hear the sound generated from the environment around the work machine 100. Because the operator can easily recognize the situation around the work machine 100, safety can be improved.

Based on the sound signal processed by the sound processing part 304, the identifying part 305 identifies whether or not a person who has spoken exists. For example, the identifying part 305 determines whether or not the sound signal from which the sound band of a person's voice is extracted has a volume greater than or equal to a predetermined threshold, and from the determination result, identifies whether or not a person who has spoken exists.

Further, when the identifying part 305 identifies that a person who has spoken exists, the identifying part 305 identifies the direction of speech based on the volume of each of the sound signals of the plurality of external sound collecting devices M1. The direction of speech is, for example, the direction in which a person who has spoken exists. For example, the identifying part 305 identifies, as the direction of speech, the direction in which the external sound collecting device M1, which has detected the sound with the highest volume, is located, among the four directions of front, rear, left, and right. Note that the present embodiment indicates an example of the direction identifying method, and is not limited to this method. For example, there is a method for identifying the direction of speech based on the phase shift and the difference in volume of sound signals of a plurality of external sound collecting devices M1.

The determining part 306 determines whether or not the direction of speech identified by the identifying part 305 and the direction in which the person exists estimated by the position estimating part 303 match.

The output control part 307 outputs information to one or more of the display device D1 and the internal sound output device SP2. For example, when a person who exists around the work machine 100 is speaking, the output control part 307 is configured to report the direction in which the sound caused by the person's speech is detected based on the direction of the sound detected by the external sound collecting devices M1. This report is performed when the direction of the person detected from the image information corresponds to the direction of speech.

For example, the output control part 307 reports the detected direction when the determining part 306 determines that the directions match, and prevents the reporting of the detected direction when the determining part 306 determines that the direction do not match (are different).

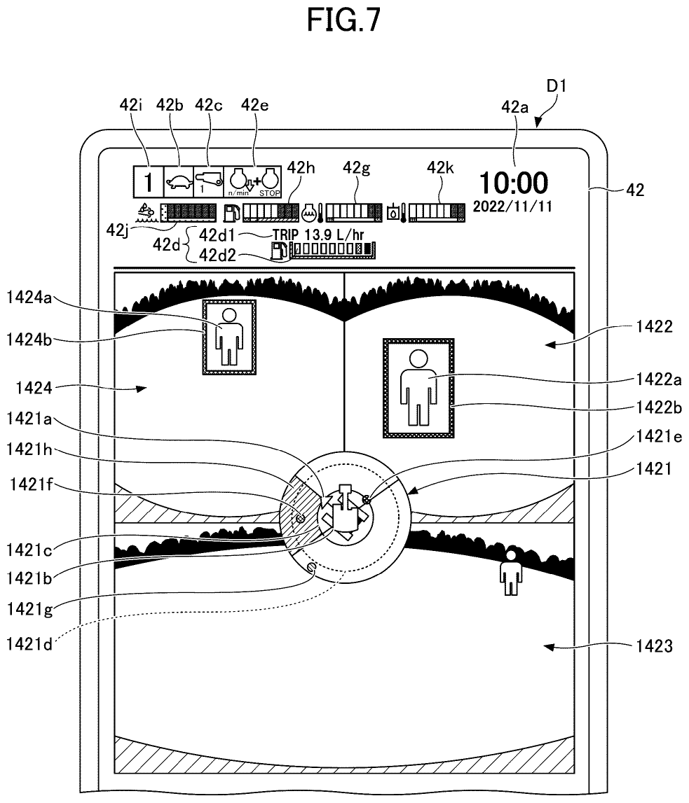

Next, with reference to FIG. 7, an example of a display screen 42 output by the output control part 307 to the display device D1 will be described. FIG. 7 is a diagram illustrating an example of a display screen 42 displayed by the display device D1 according to the present embodiment.

The output control part 307 according to the present embodiment generates a display screen 42 based on image information input from the imaging device S6, sound signals input from the external sound collecting device M1, and various kinds of information detected by various sensors or the like provided in the work machine 100. The various kinds of information detected by the various sensors or the like include a turning angle, information indicating an area in which a person is photographed in the image information, position information of a person present around the work machine 100 (information indicating the direction and distance in which the detected person is present), a person who has spoken based on sound signals input from the external sound collecting device M1, and detection results of various sensors.

The display screen 42 includes a date and time display area 42a, a travel mode display area 42b, an attachment display area 42c, a fuel consumption display area 42d, an engine control state display area 42e, a cooling water temperature display area 42g, a fuel remaining amount display area 42h, a rotation speed level display area 42i, a urea water remaining amount display area 42j, a hydraulic oil temperature display area 42k, a state display area 1421, a first image display area 1422, a second image display area 1423, and a third image display area 1424, according to the control from the output control part 307. The display screen 42 may include other display areas.

The travel mode display area 42b, the attachment display area 42c, the engine control state display area 42e, and the rotation speed level display area 42i are areas for displaying setting state information, which is information related to the setting state of the work machine 100. The fuel consumption display area 42d, the engine operation time display area, the cooling water temperature display area 42g, the fuel remaining amount display area 42h, the urea water remaining amount display area 42j, and the hydraulic oil temperature display area 42k are areas for displaying operation state information, which is information representing the operation state of the work machine 100, based on the detection results of various sensors.

The date and time display area 42a is an area for displaying the current date and time. The travel mode display area 42b is an area for displaying the current travel mode. The attachment display area 42c is an area for displaying an image representing the currently attached attachment. The fuel consumption display area 42d is an area for displaying fuel consumption information calculated by the controller 30. The fuel consumption display area 42d includes an average fuel consumption display area 42d1 for displaying lifetime average fuel consumption or section average fuel consumption and an instantaneous fuel consumption display area 42d2 for displaying instantaneous fuel consumption.

The engine control state display area 42e is an area for displaying the control state of the engine 11. The engine operation time display area is an area for displaying the cumulative operation time of the engine 11. The cooling water temperature display area 42g displays the current temperature state of the engine cooling water. The fuel remaining amount display area 42h displays the remaining amount of fuel stored in the fuel tank.

The rotation speed level display area 42i displays the current level set by the dial (not illustrated) in an image. A number indicating the selected level is displayed in the rotation speed level display area 42i. The number “1” displayed in the rotation speed level display area 42i indicates that the selected rotation speed level is the “1st level”. The number “n” displayed in the rotation speed level display area 42i indicates that the selected rotation speed level is the “nth level”. The notation of “n” is a natural number. When the operator rotates the dial (not illustrated), the number displayed in the rotation speed level display area 42i changes.

The urea water remaining amount display area 42j is an area for displaying the remaining amount of urea water stored in the urea water tank with an image. The hydraulic oil temperature display area 42k is an area for displaying the temperature state of the hydraulic oil in the hydraulic oil tank.

In the screen illustrated in FIG. 7, the first image display area 1422, the second image display area 1423, and the third image display area 1424 are areas for displaying image information captured by the imaging device S6. The first image display area 1422 displays a right image. The second image display area 1423 displays a rear image. The third image display area 1424 displays a left image. The right image is an image reflecting the space on the right side of the work machine 100, the rear image is an image reflecting the space behind the work machine 100, and the left image is an image reflecting the space on the left side of the work machine 100.

The first image display area 1422 is displayed right with reference to the state display area 1421. The second image display area 1423 is displayed downward with reference to the state display area 1421. The third image display area 1424 is displayed left with reference to the state display area 1421. It is assumed that the lower portion of the display screen 42 corresponds to the rear of the work machine 100. That is, the display screen 42 displays image information captured by the imaging device S6 in the direction captured by the imaging device S6 with the state display area 1421 as a reference. The present embodiment describes an example of the arrangement of image information, and is not limited to this arrangement. For example, the image display area may be arranged regardless of the direction captured. In the present embodiment, because the image information captured is displayed in the direction captured with the state display area 1421 as a reference, the operator can intuitively recognize which direction the image information represents when referring to the image information. Therefore, safety can be improved.

When the position and distance of the person are identified by the position estimating part 303, the output control part 307 superimposes a frame indicating that the person has been detected in the area identified by the identified position and distance on one or more of the right image, rear image, and left image.

As a result, a frame 1422b is displayed on the right image of the first image display area 1422 so as to surround the person 1422a, and a frame 1424b is displayed on the left image of the third image display area 1424 so as to surround the person 1424a.

The state display area 1421 is an area for displaying information representing a positional relationship between the work machine 100 and a person detected around the work machine 100.

The state display area 1421 is a display area representing a real space around the work machine 100 at a predetermined scale. In the state display area 1421, a work machine icon (an example of display information) 1421b indicating the presence of the work machine 100 is arranged at the center of the area.

Other than the work machine icon 1421b representing the work machine 100, a direction display icon 1421a indicating a moving direction when the work machine 100 advances and an icon (in the example of FIG. 7, the person detection icons 1421e, 1421f, and 1421g) representing a person detected around the work machine 100 are simultaneously displayed in the state display area 1421. In the state display area 1421, areas (that is, the background) other than the work machine icon 1421b, the direction display icon 1421a, the person detection icon 1421e, 1421f, 1421g, and the area 1421h may be areas represented by, for example, a single color (e.g., black).

The work machine icon 1421b is an icon that combines an image indicating the upper turning body 3 and an image indicating the lower traveling body 1 according to the positional relationship between the upper turning body 3 and the lower traveling body 1 based on the turning angle.

The direction display icon 1421a indicates, in a triangular shape, the direction in which the work machine 100 travels when the traveling lever is tilted forward. Note that the present embodiment describes an example of an icon indicating the direction in which the work machine 100 travels when the traveling lever is tilted forward, and any shape may be used as long as it indicates the direction in which the work machine 100 can travel.

The person detection icons 1421e, 1421f, and 1421g are icons representing persons detected by the image information captured by the imaging device S6. Specifically, the person detection icons 1421e, 1421f, and 1421g are arranged based on the estimation result of the position and direction of a person estimated by the position estimating part 303. For example, the person detection icons 1421e, 1421f, and 1421g are arranged at positions obtained by multiplying the direction and distance of a person indicated by the estimation result by a predetermined scale rate with the work machine 100 as a reference.

As described above, the positional relationship between the work machine icon 1421b and the person detection icons 1421e, 1421f, and 1421g corresponds to the positional relationship between the work machine 100 in the real space and the person existing around the work machine 100.

Further, the operator can estimate how the positional relationship between the work machine 100 and a person existing in the vicinity changes when the work machine 100 is moved, by referring to the state display area 1421.

Further, the state display area 1421 displays a first circular area 1421c and a second circular area 1421d determined according to the distance from the work machine 100 with the work machine 100 as a reference.

The first circular area 1421c is information indicating the turning range of the current attachment AT of the work machine 100 based on the detection results obtained by the boom angle sensor S1, the arm angle sensor S2, and the bucket angle sensor S3.

The second circular area 1421d is information indicating the turning range of the attachment AT when the attachment AT is extended most in the horizontal direction.

The display screen 42 according to the present embodiment displays a first circular area 1421c and a second circular area 1421d. That is, the positional relationship between a person and the attachment AT can be recognized by the positional relationship between the first circular area 1421c, the second circular area 1421d, and the person detection icons 1421e, 1421f, and 1421g. Therefore, the operator can easily perform an operation in which the person does not come into contact with the attachment AT, thereby improving safety.

Further, the output control part 307 changes the display mode of the person detection icons 1421e, 1421f, and 1421g according to whether they are included in the first circular area 1421c and the second circular area 1421d.

For example, the person detection icon 1421e existing in the first circular area 1421c is displayed in red. The person detection icon 1421f existing outside the first circular area 1421c and in the second circular area 1421d is displayed in yellow, for example. The person detection icon 1421g existing outside the second circular area 1421d is displayed in blue, for example. The output control part 307 according to the present embodiment implements different display modes depending on whether or not the icon is included in the first circular area 1421c and the second circular area 1421d. That is, the color of the person detection icon changes according to the distance from the work machine 100. In this way, the display device D1 can alert the operator according to the distance between the work machine 100 and the person by displaying the person detection icon whose color is changed according to the distance. Therefore, safety can be improved.

By referring to the state display area 1421, the operator can recognize how the positional relationship between the attachment AT of the work machine 100 and the person existing in the vicinity changes when the work machine 100 is turned. Therefore, safety can be improved.

The output control part 307 matches the color of the frame 1422b of the right image of the first image display area 1422 with the color of the person detection icon 1421e, and matches the color of the frame 1424b of the rear image of the third image display area 1424 with the color of the person detection icon 1421f.

That is, a frame indicating the detected person is displayed on the display screen 42 for the right image and the left image, and the correspondence relationship between the person indicated by the frame and the person detection icon is displayed recognizable. Thus, the operator can recognize the situation of the person indicated by the state display area 1421 by referring to the right image and the left image.

Further, the output control part 307 displays an area 1421h, which is identified by the identifying part 305 and indicates the direction of speech, on the state display area 1421. The area 1421h of the state display area 1421 is expressed by a color different from that of the background (another area) of the state display area 1421. That is, the output control part 307 according to the present embodiment displays the area 1421h (an example of information), which indicates the direction in which the sound from the person's speech was detected, on the display device D1 in a manner different from that of the another area (an example of information) with reference to the work machine icon 1421b. Thus, the operator can recognize the direction of speech by referring to the state display area 1421. Then, the operator can estimate which person spoke from the direction. For example, the operator can estimate that the person corresponding to the person detection icon 1421f included in the area 1421h spoke to the operator. Therefore, because the operator can estimate the person who spoke to the operator, it is easy to communicate with the person who spoke to the operator. This reduces the burden at the time of work.

Further, there is a case where the direction of speech identified by the identifying part 305 and the direction in which a person exists identified by the position estimating part 303 are slightly different.

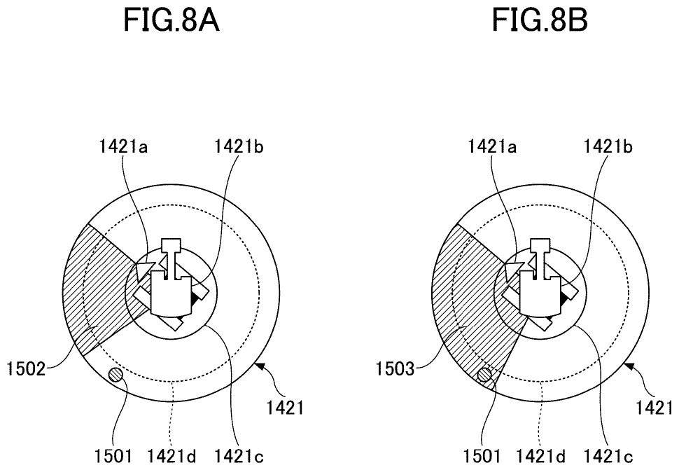

FIGS. 8A and 8B are diagrams explaining an example of correcting the direction of speech in the output control part 307 according to the present embodiment. FIG. 8A illustrates an example in which the identifying part 305 detects a sound caused by a person's speech from the left of the four directions. In this case, the output control part 307 expresses the area 1502 corresponding to the left direction with a color different from that of other areas. However, in FIGS. 8A and 8B, the position estimating part 303 estimates that a person exists in the direction and distance indicated by the person detection icon 1501.

The direction of speech identified by the identifying part 305 may be shifted depending on the surrounding environment. The output control part 307 according to the present embodiment corrects the area indicating the direction of speech according to the position where a person actually exists.

The output control part 307 corrects the area indicating the direction of speech based on the direction of the person detected from the image information identified by the position estimating part 303. The reference to be corrected may be any reference. For example, even if the direction of the person estimated by the position estimating part 303 is not included in the area indicating the direction identified by the identifying part 305, the output control part 307 corrects the area so that the direction of the person estimated by the position estimating part 303 is included if it is closer than a predetermined reference (for example, in the case of less than or equal to 10 degrees).

FIG. 8B illustrates the state display area 1421 after the output control part 307 has corrected the area. The area 1503 illustrated in FIG. 8B has been corrected to include the person detection icon 1421f. Therefore, by referring to the state display area 1421 illustrated in FIG. 8B, the operator can recognize the person who has spoken to him/her and communicate with the person. As described above, in the present embodiment, even if the direction of speech identified by the external sound collecting device M1 is shifted, the output control part 307 corrects the direction of speech based on the direction of the person detected from the image information, so that the direction of speech can be presented to the operator without giving the feeling that something is wrong. Therefore, when the operation of the work machine 100 is required based on the spoken content, the operator can identify which direction the spoken content is based and which direction the work machine 100 is to be operated, such that convenience can be improved.

FIG. 7 illustrates an example of the display screen 42 displayed by the output control part 307, but the direction of speech may be expressed by another mode.

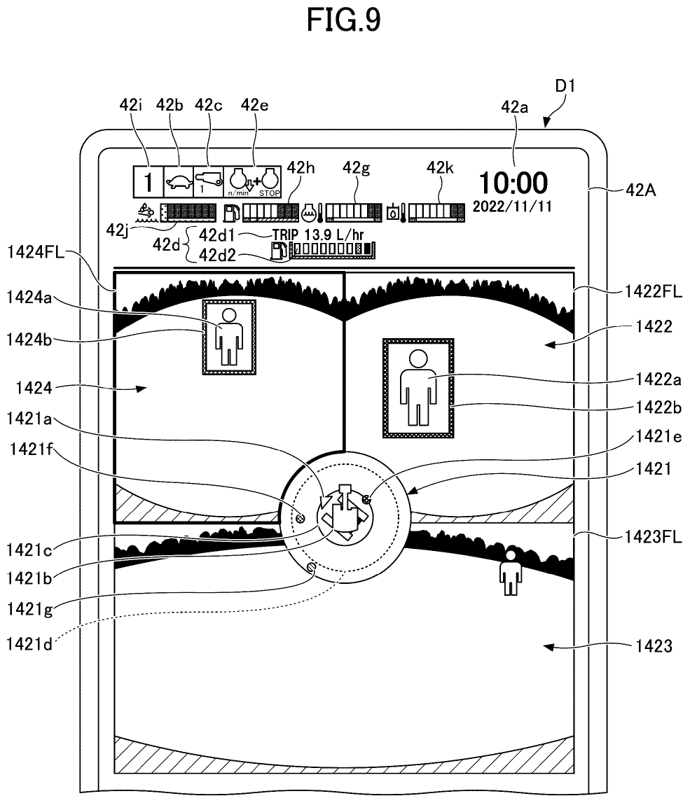

FIG. 9 illustrates an example of a display screen 42A displayed by the display device D1 according to the present embodiment. The same display as in FIG. 7 is assigned the same reference numerals and a description thereof is omitted.

In the screen illustrated in FIG. 9, the first image display area 1422, the second image display area 1423, and the third image display area 1424 are areas for displaying image information captured by the imaging device S6.

Further, the output control part 307 displays information indicating the direction of speech identified by the identifying part 305 on the outer frame of one or more of the first image display area 1422, the second image display area 1423, and the third image display area 1424.

In the example illustrated in FIG. 9, the outer frame 1424FL of the third image display area 1424 is thicker than the outer frame 1422FL of the first image display area 1422 and the outer frame 1423FL of the second image display area 1423. Further, the outer frame 1424FL is expressed by a different color to that of the outer frames 1422FL and 1422FL.

The operator can recognize the direction of speech by referring to the first image display area 1422, the second image display area 1423, and the third image display area 1424. That is, because the outer frame 1424FL has a different display mode from that of the other outer frames, the operator can presume that the person who appears in the third image display area 1424 surrounded by the outer frame 1424FL has spoken. Therefore, because the operator can estimate the person who has spoken, it becomes easy to communicate with the person who has spoken.

If the direction of speech is the forward direction, the person who has spoken does not appear in any of the first image display area 1422, the second image display area 1423, or the third image display area 1424. In this case, there is a method in which the output control part 307 displays a message on the display device D1 indicating that a voice is heard from the front side and the screen is switched to a screen in which the front side is appearing. As another method, there is a method in which the output control part 307 automatically switches to a display screen including an image which is captured by the camera S6F and in which the space in front of the work machine 100 is appearing.

In the example illustrated in FIG. 9, the output control part 307 displays the image information captured by the imaging device S6 on the display device D1, and displays the direction in which the sound caused by a person's speech was detected by changing the display mode of the outer frame of the captured image information. Therefore, the operator can recognize the direction of the speech and the current situation of the direction. Therefore, the operator can easily estimate the person who spoke and communicate with the person who spoke.

The display screens 42 and 42A illustrated in FIGS. 7 to 9 illustrate one mode of displaying the surrounding area of the work machine 100, and the surrounding area of the work machine 100 may be expressed by other modes. As a method of displaying the surrounding area of the work machine 100, a bird's-eye view image may be used.

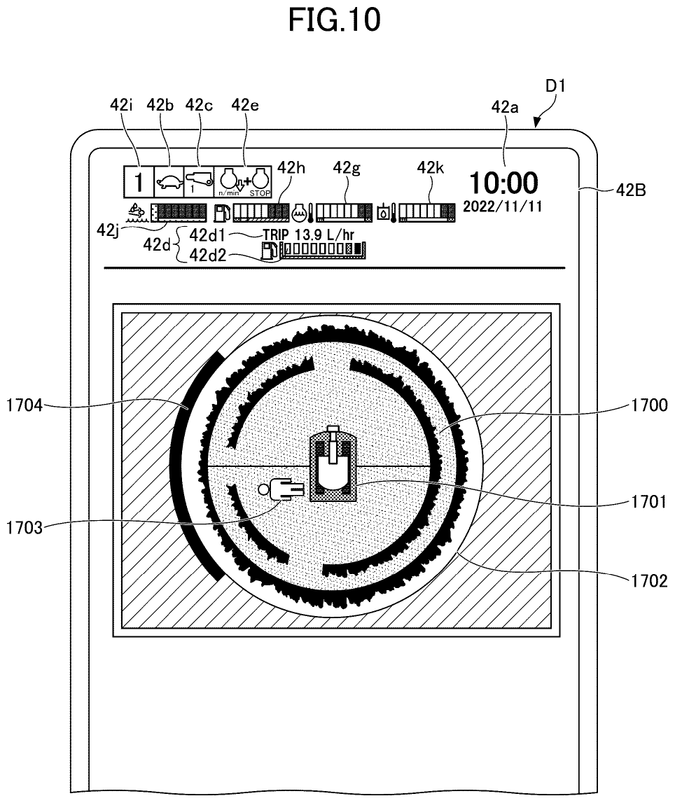

FIG. 10 illustrates an example of a display screen 42B displayed by the display device D1 according to the present embodiment. The same display as that illustrated in FIG. 7 is assigned the same reference numerals and a description thereof is omitted.

In the screen illustrated in FIG. 10, a bird's-eye view image 1700 is image information expressing the surrounding area of the work machine 100 from above the work machine 100 with reference to the work machine icon 1701. The bird's-eye view image 1700 is image information generated by each of the four cameras S6F, S6B, S6L, and S6R based on image information. The output control part 307 according to the present embodiment combines the image information captured from the front, the image information captured from the rear, the image information captured from the right, and the image information captured from the left, and converts them into an image seen from just above the work machine 100 to generate the bird's-eye view image 1700.

In the example illustrated in FIG. 10, the output control part 307 superimposes a thick line 1704 indicating the area where the person who spoke is present on the outer frame 1702 of the bird's-eye view image 1700 to be displayed. The thick line 1704 may have a different color than that of the outer frame 1702 of the bird's-eye view image 1700.

By referring to the bird's-eye view image 1700, the operator can recognize the left direction indicated by the thick line 1704 as the direction of speech with reference to the work machine 100. Therefore, the operator can assume that the person 1703 in the bird's-eye view image 1700 has spoken to the operator.

Therefore, because the controller 30 according to the present embodiment can estimate the person who spoke, it is easy to communicate with the person who spoke to the operator. Therefore, the work load is reduced.

Although the example illustrated in FIG. 10 illustrates an example of displaying only the bird's-eye view image 1700, the mode is not limited to the mode of displaying only the bird's-eye view image 1700, and the bird's-eye view image 1700 may be displayed in combination with any one or more of the first image display area 1422 of the right image, the second image display area 1423 of the rear image, and the third image display area 1424 of the left image as illustrated in FIGS. 8A to 9. For example, there is a method in which the output control part 307 outputs a display screen in which the bird's-eye view image 1700, the first image display area 1422, and the second image display area 1423 are combined.

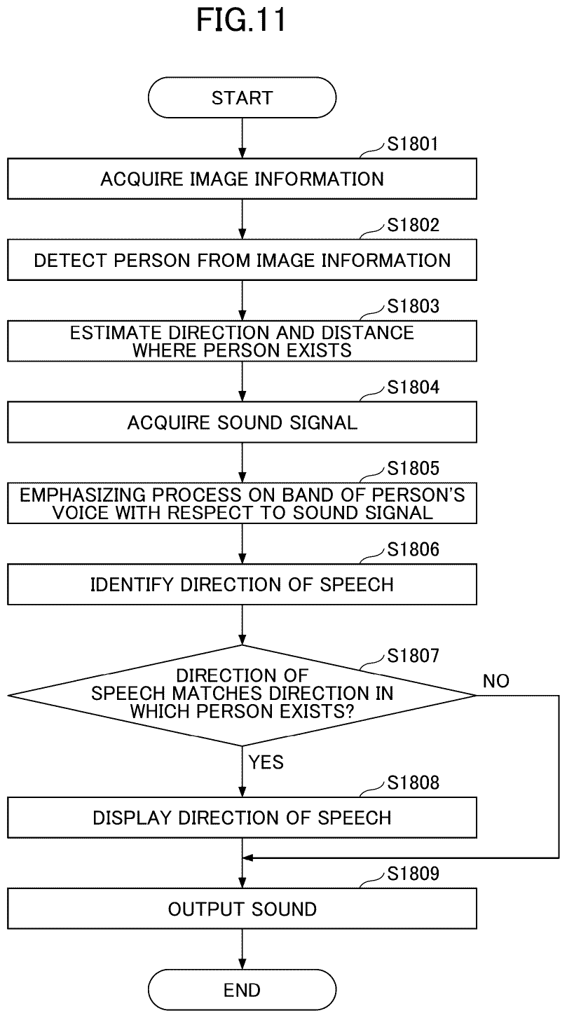

Next, the processing procedure executed by the controller 30 according to the present embodiment will be described. FIG. 11 is a flowchart illustrating the processing procedure for displaying the direction of speech by the controller 30 according to the present embodiment.

First, the acquiring part 301 acquires image information obtained by capturing the surrounding area of the work machine 100, from the imaging device S6 (S1801).

The detecting part 302 detects a person existing around the work machine 100 from the image information acquired by the acquiring part 301 (S1802).

When a person is detected by the detecting part 302, the position estimating part 303 estimates the direction and distance in which the person exists with reference to the work machine 100 (S1803).

Next, the acquiring part 301 acquires sound signals representing sounds generated around the work machine 100 from each of the plurality of external sound collecting devices M1 (S1804).

With respect to the sound signals of each of the external sound collecting devices M1 acquired by the acquiring part 301, the sound processing part 304 performs an emphasizing process on the band of the person's voice and performs a reduction process (noise removal process) for the band other than the band of the person's voice (S1805).

The identifying part 305 identifies the direction of speech based on the sound signal processed by the sound processing part 304 (S1806).

The determining part 306 determines whether the direction of speech identified by the identifying part 305 corresponds to the direction in which a person exists estimated by the position estimating part 303 (S1807).

If the determining part 306 determines that the directions of speech do not match (S1807: NO), the display of the direction of speech is prevented and the process proceeds to S1809.

On the other hand, if the determining part 306 determines that the directions of speech match (S1807: YES), the output control part 307 displays the direction of speech (S1808). For example, the output control part 307 performs display in any one of the modes of the display screen 42 in FIG. 7, the display screen 42A in FIG. 9, and the display screen 42B in FIG. 10.

Further, the output control part 307 outputs the sound signal processed by the sound processing part 304 (S1809).

In the present embodiment, the operator can recognize the direction of speech around the work machine 100 by performing the processing procedure described above. Because the operator can estimate the person who spoke by visually recognizing the direction of speech, it is easy to communicate with the person who spoke.

Further, in the present embodiment, by performing an emphasizing process on the band of the person's voice and outputting the sound signal from which noise is removed, it is easy for the operator to identify what the person who exists around the work machine 100 said.

The present embodiment describes an example of the arrangement of the external sound collecting device M1, but the arrangement is not limited to this arrangement example. For example, one or more microphone arrays may be provided in the upper turning body 3. The microphone array has a plurality of microphones, and the direction in which the sound is generated can be recognized by processing and analyzing the difference (time difference, phase difference) of the sound perceived by the plurality of microphones. When one microphone array having such directivity is provided, the direction of the sound can be detected from the sound detected by each of the microphones included in the microphone array.

In the present embodiment, an example of providing four external sound collecting devices M1 has been described. However, the present embodiment does not limit the number of external sound collecting devices M1 attached to the work machine 100, and the number may be three or less, or five or more.

### Modified Example

In the present embodiment, an example of displaying the direction on the display device D1 has been described as the reporting method. However, the above-described embodiment does not limit the reporting method to the method of displaying the direction on the display device D1. In this modified example, a plurality of internal sound output devices SP2 are provided in the driving room 10. The internal sound output devices SP2 are provided, for example, in the driving room 10 at the front, rear, left, and right directions with reference to the operator seat.

The identifying part 305 according to this modified example identifies the direction of speech based on sound signals from the four external sound collecting devices M1, and the output control part 307 controls the output of sound from the internal sound output device SP2 corresponding to the direction of speech among the plurality of internal sound output devices SP2. In this modified example, the operator can recognize the direction of speech from the direction in which the sound is output. Note that the work machine 100 according to this modified example does not have to be provided with the imaging device S6.

This modified example describes one mode of the reporting method, and other modes may be used. For example, the driving room 10 may be provided with a plurality of light sources, and the output control part 307 may control the light source corresponding to the direction of speech among the plurality of light sources. As another example, each of the plurality of operation levers of the operation device 26 may be provided with a vibration mechanism, and the output control part 307 may control the vibration mechanism corresponding to the direction existing in the direction of speech to vibrate, among the plurality of operation levers. In this modified example, because the right and left operation levers are provided, the direction of speech can be intuitively recognized only in the lateral direction. In this modified example, the operator can recognize the direction of speech by performing the above-described reporting method. Therefore, the operator can estimate the person who spoke by visually recognizing the direction of speech, and it becomes easy to communicate with the person who spoke.

The reporting method is not limited to one mode, and a plurality of modes may be combined. For example, two or more of the following may be combined: display of the direction on the display device D1, output of sound from the internal sound output device SP2 corresponding to the direction, lighting of the light source corresponding to the direction, and vibration of each of the plurality of operation levers of the operation device 26.

### Second Embodiment

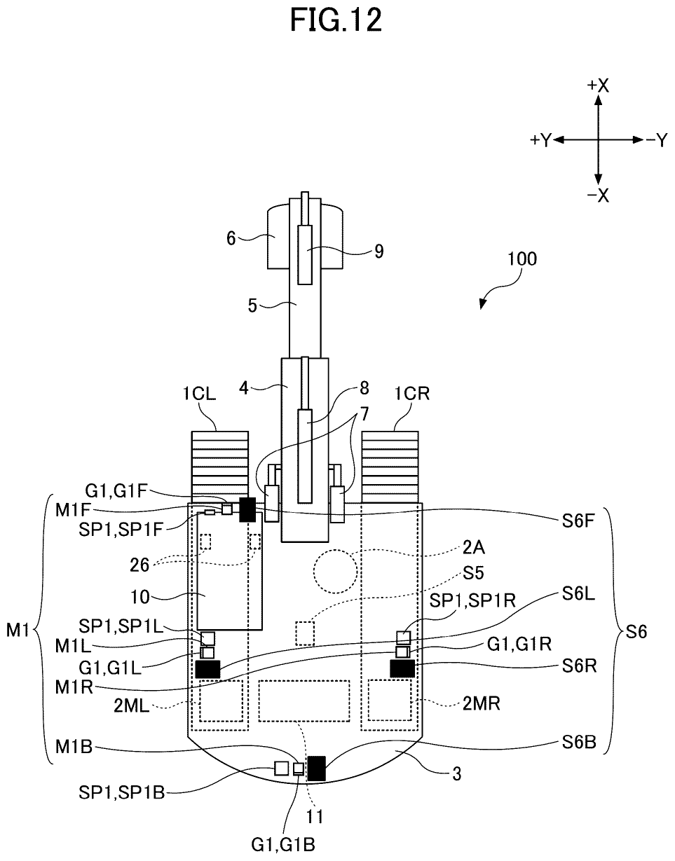

Next, another configuration example of the work machine 100 according to the second embodiment will be described with reference to FIG. 12. FIG. 12 is a top view of another configuration example of the work machine 100 according to the second embodiment. The work machine 100 illustrated in FIG. 12 differs from the work machine 100 illustrated in FIG. 1 in that the external sound output device SP1 includes four speakers (a front speaker SP1F, a left speaker SP1L, a right speaker SP1R, and a rear speaker SP1B). In the work machine 100 illustrated in FIG. 1, the external sound output device SP1 includes one non-directional speaker provided above the driving room 10.

With this configuration, the work machine 100 illustrated in FIG. 12 can output sound toward the workers WK in front of the work machine 100 without outputting sound toward the worker WK at the left, right, and rear of the work machine 100, by turning on the front speaker SP1F (the state in which sound can be output) and turning off the left speaker SP1L, the right speaker SP1R, and the rear speaker SP1B (the state in which sound cannot be output), for example.

In the example illustrated in FIG. 12, the front camera S6F and the front microphone M1F are provided adjacent to the front speaker SP1F, and the front light bar G1F is provided in the case of the front microphone M1F. The left camera S6L and the left microphone M1L are provided adjacent to the left speaker SP1L, and the left light bar G1L is provided in the case of the left microphone M1L. The right camera S6R and the right microphone M1R are provided adjacent to the right speaker SP1R, and the right light bar G1R is provided in the case of the right microphone M1R. The rear camera S6B and the rear microphone M1B are provided adjacent to the rear speaker SP1B, and the rear light bar G1B is provided in the chassis of the rear microphone M1B.

In this case, the work machine 100 may turn on the light bar corresponding to the turned on speaker (light emission enabled state) and turn off the light bar corresponding to the turned off speaker (light emission disabled state).

The external sound output device SP1 may include one or a plurality of parametric speakers. The parametric speaker is a speaker using ultrasonic waves that can selectively transmit sound to a person within a specific narrow range. The parametric speaker can transmit sound to any position.

In the work machine 100 illustrated in FIG. 12, the controller 30 may detect the worker WK around the work machine 100 based on the image captured by the imaging device S6, and identify the position of the worker WK. If there are a plurality of workers WK around the work machine 100, the controller 30 may discriminate between the conversation target (the worker WK who is speaking) and the non-target (the worker WK who is not speaking) based on the outputs of the four external sound collecting devices M1. The controller 30 may discriminate between the conversation target (the worker WK who is facing the work machine 100) and the non-target (the worker WK who is not facing the work machine 100) based on the image captured by the imaging device S6. Then, the controller 30 may turn on the speaker and the light bar facing the worker WK. For example, if there is a worker WK (speaking) behind the work machine 100, the controller 30 may turn on the rear speaker SP1B while keeping the front speaker SP1F, the left speaker SP1L, and the right speaker SP1R off. In this case, the controller 30 may turn on the rear light bar G1B while keeping the front light bar G1F, the left light bar G1L, and the right light bar G1R off. Such a function may be implemented in the work machine 100 illustrated in FIGS. 1 to 5.

With this configuration, the controller 30 can output sound in the direction where the worker WK is located without outputting sound in the direction where the worker WK is not located. Therefore, the worker WK can easily recognize whether he/she is a conversation target or a non-target.

### Third Embodiment

In the third embodiment, a case where the operator performs remote operation of the work machine 100 will be described.

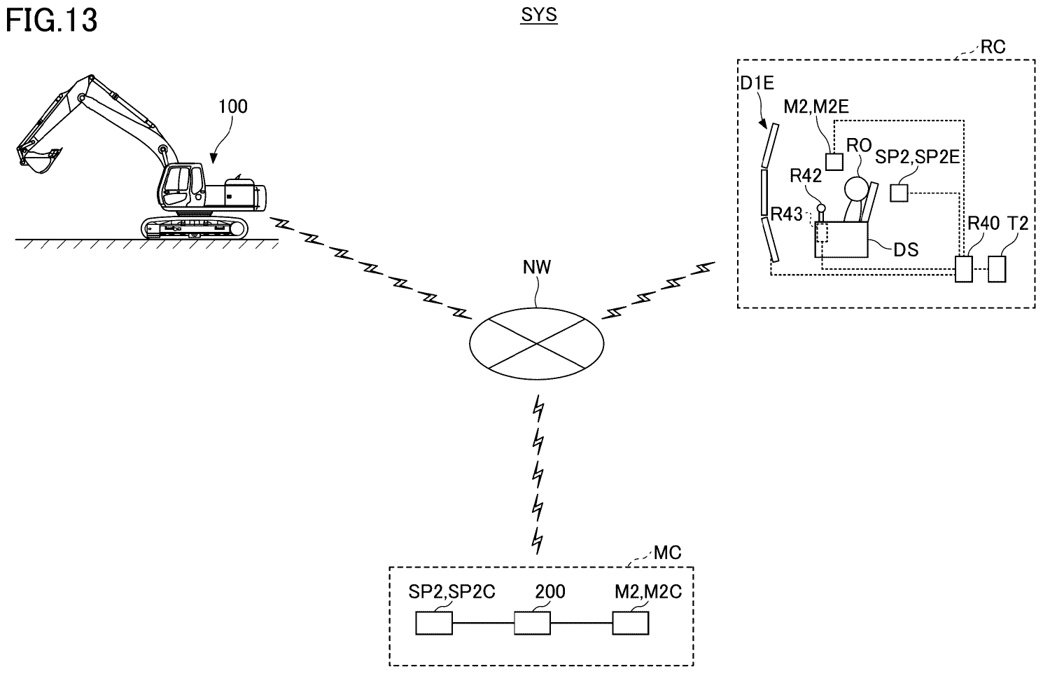

Next, with reference to FIG. 13, a configuration example of the operation system (one example of a control system) SYS according to the third embodiment will be described. FIG. 13 is a schematic diagram illustrating a configuration example of the operation system (one example of a control system of a work machine) SYS of the work machine 100. As illustrated in FIG. 13, the operation system SYS includes the work machine 100, the remote control room RC, and the management center MC. In FIG. 13, the detailed configuration of the work machine 100 is not illustrated. This is because the work machine 100 illustrated in FIG. 13 has the same configuration as the work machine 100 illustrated in FIG. 1 or 10.

The work machine 100, the remote control room RC, and the management center MC are connected to each other so that data can be transmitted and received via the communication network NW. The work machine 100, the remote control room RC, and the management center MC may be connected to each other so that data can be transmitted and received directly without the communication network NW. In the illustrated example, the work machine 100 transmits information about the work site to the remote control room RC. Thus, the remote operator RO in the remote control room RC can identify the situation of the work site based on the information from the work machine 100.

For example, the work machine 100 transmits image information captured by the imaging device S6 and a sound signal representing sound collected by the external sound collecting device M1 to the remote control room RC.

The work machine 100 is provided with a sensor capable of recognizing the position and shape of objects in the work site in three dimensions. For example, the work machine 100 is provided with a space recognition device. Therefore, the work machine 100 can transmit the result of measuring the work site in three dimensions to the remote control room RC.

The space recognition device is a device for recognizing the space around the work machine 100. In the illustrated example, the space recognition device is a LiDAR. The LiDAR measures the distance between each of 1 million or more points within the monitoring range and the LiDAR. The space recognition device may be any device capable of measuring the distance to an object. For example, the space recognition device may be a stereo camera or a combination of the imaging device S6 and a distance measuring device such as a millimeter wave radar.

The work machine 100 included in the operation system SYS may be one or more machines. When a plurality of work machines 100 are included, the remote operator RO of a specific work machine 100 can obtain information on the working site obtained by one or more other work machines 100 in addition to the information on the working site obtained by the specific work machine 100.

A communication device T2, a remote controller R40, an operation device R42, an operation sensor R43, a display device D1E, an internal sound collecting device M2E, and an internal sound output device SP2E are installed in the remote control room RC. An operation seat DS on which the remote operator RO who remotely operates the work machine 100 sits is installed in the remote control room RC.

The communication device T2 is configured to communicate with the communication device T1 attached to the work machine 100.

The remote controller R40 is an operation device that executes various operations. In the present embodiment, the remote controller R40 is composed of a microcomputer including a CPU and a memory. Various functions of the remote controller R40 are implemented by the CPU executing programs stored in the memory.

The display device DiE can display various kinds of information. The display device DiE displays an image based on information transmitted from the work machine 100 in order for the remote operator RO in the remote control room RC to visually recognize the surroundings of the work machine 100. In the illustrated example, the display device DiE is a liquid crystal display. Note that the display device DiE may be a display or a projector for implementing the naked-eye stereoscopic vision, or VR goggles or the like.

The internal sound collecting device M2E is a device for collecting sounds generated in the remote control room RC. In the illustrated example, the internal sound collecting device M2E is an indoor microphone, and is configured to pick up voices emitted by the remote operator RO in the remote control room RC.

The internal sound output device SP2E can output various kinds of sound information. The internal sound output device SP2E outputs sound based on information transmitted from the work machine 100 so that the remote operator RO in the remote control room RC can hear the sound emitted at the work site. For example, the internal sound output device SP2E may be configured to output the sound captured by the external sound collecting device M1 mounted outside the driving room 10 or the internal sound collecting device M2 mounted inside the driving room 10. In this case, the internal sound collecting device M2 may be provided in the driving room 10 at a position corresponding to the ear position of the operator sitting on the driving seat 50. The internal sound output device SP2E may be an installed device such as a speaker or a wearable device such as an earphone or a headphone. The speaker may be a monaural speaker, a stereo speaker, or a surround speaker. The speaker may be a non-directional speaker or a directional speaker. The wearable device may have a noise canceling function, a spatial audio function (stereo sound function), or a bone conduction function.

An operation sensor R43 for detecting the operation contents of the operation device R42 is installed in the operation device R42. The operation sensor R43 is, for example, an inclination sensor for detecting the inclination angle of the operation lever or an angle sensor for detecting the oscillation angle of the operation lever around the oscillation shaft. The operation sensor R43 may be composed of other sensors such as a pressure sensor, a current sensor, a voltage sensor, or a distance sensor. The operation sensor R43 outputs information about the detected operation contents of the operation device R42 to the remote controller R40. The remote controller R40 generates an operation signal based on the received information and transmits the generated operation signal to the work machine 100. The operation sensor R43 may be configured to generate an operation signal. In this case, the operation sensor R43 may output the operation signal to the communication device T2 without passing through the remote controller R40. With this configuration, the remote operator RO can remotely operate the work machine 100 from the remote control room RC.

Like the controller 30 of the first embodiment, the remote controller R40 includes an acquiring part 301, a detecting part 302, a position estimating part 303, a sound processing part 304, an identifying part 305, a determining part 306, and an output control part 307.

The acquiring part 301 of the remote controller R40 acquires a sound signal representing the sound collected by the external sound collecting device M1 from the work machine 100 via the communication device T2. Further, the acquiring part 301 acquires a sound signal representing the sound collected by the internal sound collecting device M2E of the remote control room RC.

The output control part 307 of the remote controller R40 can implement control, via the communication device T2, to output the sound based on the sound signal acquired from the external sound collecting device M1 by the acquiring part 301, from the internal sound output device SP2E of the remote control room RC. Thus, the remote operator RO can hear the sound of a person existing around the work machine 100.

The output control part 307 of the remote controller R40 can implement control, via the communication device T2, to output the sound based on the sound signal acquired from the internal sound collecting device M2E of the remote control room RC by the acquiring part 301, from the external sound output device SP1 of the work machine 100. Thus, a person existing around the work machine 100 can hear the voice of the remote operator RO.

The detecting part 302, the position estimating part 303, the sound processing part 304, the identifying part 305, and the determining part 306 of the remote controller R40 perform the same control as the controller 30 of the above-described embodiment.

With this configuration, the remote controller R40, similar to the controller 30 described above, identifies the direction of speech based on the acquired sound signal. Then, the remote controller R40 displays the display screen 42 illustrated in FIG. 7, the display screen 42A illustrated in FIG. 9, or the display screen 42B illustrated in FIG. 10 on the display device DR as in the embodiment described above.

The management center MC is a facility provided with various devices for managing the remote operation of the work machine 100 by the remote operator RO in the remote control room RC. In the illustrated example, the management center MC is installed at a position apart from the work site of the work machine 100 and the remote control room RC. In the management center MC, the management device 200, the internal sound collecting device M2C, and the internal sound output device SP2C are installed.

The management device 200 is an example of a control device, such as a server computer (what is referred to as a cloud server) or an edge server. The management device 200 is typically a fixed terminal device, but may be a portable terminal device (for example, a laptop computer, a tablet, or a smartphone). The management device 200 can perform the same control as the remote controller R40.

With this configuration, the manager in the management center MC can listen to the sound generated at the work site by using, for example, the sound collecting device (the external sound collecting device M1 or the internal sound collecting device M2) and the internal sound output device SP2C attached to the work machine 100. The manager in the management center MC can listen to the sound generated in the remote control room RC by using, for example, the internal sound collecting device M2E and the internal sound output device SP2C attached to the remote control room RC. Further, the manager in the management center MC can transmit his/her voice to the worker WK around the work machine 100 by using, for example, the internal sound collecting device M2C and the external sound output device SP1 attached to the work machine 100. The manager in the management center MC can transmit his/her voice to the remote operator RO in the remote control room RC by using, for example, the internal sound collecting device M2C and the internal sound output device SP2E attached to the remote control room RC.

The management device 200 has the same configuration as the remote controller R40. Therefore, the management device 200 displays the display screen 42 illustrated in FIG. 7, the display screen 42A illustrated in FIG. 9, or the display screen 42B illustrated in FIG. 10 on the display device DR as in the above-described embodiments.

In the present embodiment, the internal sound collecting device M2C and the internal sound output device SP2C implement the same functions as the internal sound collecting device M2E and the internal sound output device SP2E, and the management device 200 transmits and receives sound signals with the work machine 100 or the remote control room RC. Therefore, the manager in the management center MC implements a two-way conversation between the remote operator RO in the remote control room RC and the person (including the worker WK) who exists around the work machine 100. The specific control for implementing the two-way conversation is the same as in the above-described embodiments, and a description is omitted.

Thus, in the present embodiment, a two-way conversation is implemented between the remote operator RO on the operation seat DS and the person who exists around the work machine 100. Similarly, a two-way conversation is implemented between the manager who manages the work site with the management device 200 and the person who exists around the work machine 100. Therefore, it is easy to communicate with the person who exists around the work machine 100 even in the case of remote operation or remote management.

Further, in the present embodiment, the remote operator RO on the operation seat DS and the manager in the management center MC can confirm the direction of speech around the work machine 100. Therefore, even when remote control or remote management is performed, it is easy to communicate with a person who exists around the work machine 100.

### <Functions>

In the above-described embodiments and modified example, the operator can recognize the direction of speech around the work machine 100. Therefore, the operator can easily communicate with the person who has spoken. Further, because the operator can identify the situation around the person who has spoken, the operator can recognize the intention of the speech. The operator can know how to operate the work machine 100 according to the intention of the speech. Therefore, in the embodiments and the modified example, the work efficiency of the work machine 100 can be improved.

The work machine and the control system of the work machine according to the present invention have been described in the above embodiments, but the present invention is not limited to the above-described embodiments. Various changes, corrections, substitutions, additions, deletions and combinations are possible within the scope of the claims. These also naturally fall within the scope of the present invention. Additionally, the modifications are included in the scope of the invention.

What is claimed is:

1. A work machine comprising:
a lower traveling body;
an upper turning body mounted on the lower traveling body so as to freely turn;
a sound collecting device provided on the upper turning body so as to be able to detect a direction of a sound around the work machine; and
a control device configured to report a direction of speech based on the direction of the sound detected by the sound collecting device, when a person existing around the work machine is speaking.

2. The work machine according to claim 1, wherein the control device reports the direction of speech by one or more of methods including displaying the direction of speech on a display device; outputting the sound from a sound output device corresponding to the direction of speech among a plurality of the sound output devices provided inside a driving room; lighting a light source corresponding to the direction of speech among a plurality of the light sources; and vibrating an operation device corresponding to the direction of speech among a plurality of the operation devices.

3. The work machine according to claim 2, wherein the control device displays information indicating the direction of speech on the display device in a display mode that is different from that of information indicating another direction, with reference to display information indicating the work machine.

4. The work machine according to claim 3, wherein
the upper turning body is further provided with an imaging device, and
the control device displays a bird's-eye view image indicating a surrounding area of the work machine from above the work machine based on image information captured by the imaging device, and displays the information indicating the direction of speech in the display mode that is different from that of the information indicating the other direction, with reference to the display information indicating the work machine included in the bird's-eye view image.

5. The work machine according to claim 2, wherein
the upper turning body is further provided with a plurality of imaging devices, and
the control device displays image information captured by the plurality of imaging devices on the display device with reference to the work machine, in such a manner that the image information capturing the direction of speech is displayed in a display mode different from that of the image information of another direction.

6. The work machine according to claim 1, wherein
the upper turning body is further provided with an imaging device, and
the control device corrects the direction of speech based on a direction of a person detected from image information captured by the imaging device.

7. The work machine according to claim 1, wherein
the upper turning body is further provided with an imaging device, and
the control device prevents reporting of the direction of speech when a direction of a person detected from image information captured by the imaging device is different from the direction of speech.

8. The work machine according to claim 1, wherein
a plurality of the sound collecting devices are provided, and
each of the plurality of sound collecting devices is provided at a different position of the upper turning body so as to be able to detect the direction of the sound around the work machine.

9. The work machine according to claim 8, wherein
the control device prevents a sound generated from the work machine based on a sound signal input from the plurality of sound collecting devices.

10. A control system for a work machine comprising:
the work machine including:
a lower traveling body;
an upper turning body mounted on the lower traveling body so as to freely turn; and
a sound collecting device provided on the upper turning body so as to be able to detect a direction of a sound around the work machine, and
a control device configured to report a direction of speech based on the direction of the sound detected by the sound collecting device, when a person existing around the work machine is speaking.
